(19) United States
(12) Patent Application Publication
(10) Pub. No.: US 2018/0359272 A1
(43) Pub. Date: Dec. 13, 2018

(54) NEXT-GENERATION ENHANCED COMPREHENSIVE CYBERSECURITY PLATFORM WITH ENDPOINT PROTECTION AND CENTRALIZED MANAGEMENT

(71) Applicant: ARIM Technologies Pte Ltd., Singapore (SG)

(72) Inventors: Liad Mizrachi, Singapore (SG); Ivan Goh, Singapore (SG)

(21) Appl. No.: 16/006,801

(22) Filed: Jun. 12, 2018

Related U.S. Application Data
(60) Provisional application No. 62/518,577, filed on Jun. 12, 2017.
(60) Provisional application No. 62/518,567, filed on Jun. 12, 2017.

(51) Int. Cl. H04L 29/06; H04L 12/24; H04L 29/08; G06F 21/55; G06F 21/56

(52) U.S. Cl. CPC H04L 63/1425; H04L 63/1441; G06F 21/56; H04L 67/22; G06F 21/552; H04L 41/0873

(57) ABSTRACT

A next-generation enhanced comprehensive cybersecurity platform, comprising a user entity behavior analytics server that analyzes user behavior across security endpoints and prevents unauthorized activity, and a plurality of next-generation endpoint protection software agents operating on security endpoints that collect activity and OS information and send it to the user entity behavior analytics server for analysis, and a method for malware detection and mitigation using a next-generation enhanced comprehensive cybersecurity platform.

### CROSS-REFERENCE TO RELATED APPLICATIONS

This application claims benefit of, and priority to, U.S. provisional patent application Ser. No. 62/518,577, titled “Next-Generation Enhanced Comprehensive Cybersecurity Platform”, which was filed on Jun. 12, 2017, and also claims benefit of, and priority to, U.S. provisional patent application Ser. No. 62/518,567, titled “SYSTEM AND METHOD FOR CLOUD-CONNECTED AGENT-BASED NEXT-GENERATION ENDPOINT PROTECTION”, which was filed on Jun. 12, 2017, the entire specifications of each of which are incorporated herein by reference.

### BACKGROUND OF THE INVENTION

### Field of the Art

The disclosure relates to the field of cybersecurity, and more particularly to the field of managed detection and response platforms.

### Discussion of the State of the Art

Cybersecurity is a huge challenge for large enterprises and other organizations (government agencies, non-profits, and so forth). The current approach entails using many point solutions in an attempt to keep up with rapid changes in the threat environment, which opens many new opportunities “between the cracks” of point solutions for hostile actors to exploit. For example, in many organizations today, a Security Information and Event Management (SIEM) solution is like a “white elephant,” expensive to maintain and adding very little value to the overall security posture of the organization. Many organizations do not even reap 50% of the true potential of a SIEM solution, reducing it to a tool used for generating reports to satisfy auditors and to comply with regulatory requirements. Similarly, anti-virus solutions used in the marketplace as point solutions have largely failed, due to the delay in responding to zero-day attacks, and also because they are designed with a single threat profile in mind, with many evasive techniques available to malware users (e.g., evading signatures, evading scanners, evading heuristics, file splitting, zero-day exploits, sandbox evasion, obfuscation and encoding of malware, etc.).

What is needed a next-generation enhanced comprehensive cybersecurity platform that provides cloud-connected, agent-based next-generation endpoint protection.

### SUMMARY OF THE INVENTION

Accordingly, the inventor has conceived and reduced to practice, a next-generation enhanced comprehensive cybersecurity platform.

According to an aspect, a managed detection and response (MDR) service is provided that uses a novel approach. The service aims to remove the burden from clients of having to figure out “what method or device to use” for a security monitoring and response capability. The invention focuses on specific outcomes—threat detection, with 24/7 monitoring and alerting, remote incident investigation, and automated malware responses included as parts of an end-to-end service. According to an aspect, the focus is on advanced or targeted attacks that have bypassed existing perimeter controls (e.g., next-generation firewalls [NGFWs], secure web gateways [SWGs], network intrusion detection systems [NIDSs], and the like). According to an aspect, advanced security forensics and analysis that utilizes advanced data analytics is provided, but not exclusively, at the core of the MDR service. Also provided are incident validation and remote remediation services; these may include, but are not limited to, reverse malware engineering, advanced memory forensics, and remediation actions.

According to one aspect, a next-generation enhanced comprehensive cybersecurity platform, comprising: a user entity behavior analytics server comprising at least a processor, a memory, and a plurality of programming instructions stored in the memory and operating on the processor, wherein the programmable instructions, when operating on the processor, cause the processor to: receive activity information from a plurality of next-generation endpoint protection agents; analyze at least a portion of the activity information, the analysis comprising at least a comparison against a stored configuration; direct the operation of a next-generation endpoint protection agent based at least in part on the analysis; receive a plurality of notification messages via a network; arrange at least a portion of the notification messages into a priority queue, the arrangement being based at least in part on a stored configuration; transmit at least a notification message based at least in part on the priority queue; a next-generation endpoint protection software agent comprising at least another processor, another memory, and another plurality of programming instructions stored in the another memory, the another plurality of programming instructions, when executed by the another processor, cause the another processor to: collect metadata based at least in part on an operating system operating on the another processor; capture activity information comprising at least a process operating on the another processor; transmit at least a portion of the activity information to a user entity behavior analytics server; receive instructions from a user entity behavior analytics server; and stop a process from operating on the another processor based on the instructions received, is disclosed.

According to another aspect, a method for malware detection and mitigation using a next-generation enhanced comprehensive cybersecurity platform, comprising the steps of: collecting, at a next-generation endpoint protection software agent comprising at least another processor, another memory, and another plurality of programming instructions stored in the another memory, metadata based at least in part on an operating system operating on the another processor; capturing activity information comprising at least a process operating on the another processor; transmitting at least a portion of the activity information to a user entity behavior analytics server; receiving, at a user entity behavior analytics server comprising at least a processor, a memory, and a plurality of programming instructions stored in the memory and operating on the processor, the activity information; analyzing at least a portion of the activity information, the analysis comprising at least a comparison against a stored configuration; and directing the operation of a next-generation endpoint protection agent based at least in part on the analysis, is disclosed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a system diagram of an exemplary arrangement for a next-generation enhanced comprehensive cybersecurity platform, according to an aspect.

FIG. 2 is an illustrating the function of a UEBA server, according to an aspect.

FIG. 3 is a flow diagram of an exemplary method for using a UEBA server to provide enhanced SIEM, according to an aspect.

FIG. 4 is a table illustrating several benefits of using a UEBA server to provide machine-learning-driven enhanced SIEM, according to an aspect.

FIG. 5 is a flow diagram illustrating an exemplary method for user behavior analytics using a UEBA server, according to an aspect.

FIG. 6 is a block diagram of an exemplary logical arrangement of administration functions provided by a UEBA server, according to an aspect.

FIG. 7 is a block diagram of an exemplary logical arrangement of deployment functions for NGEPP software agents, according to an aspect.

FIG. 8 is a block diagram of an exemplary logical arrangement of operations provided by an NGEPP software agent, according to an aspect.

FIG. 9 is a block diagram of an exemplary logical arrangement of recording functions provided by an NGEPP software agent, according to an aspect.

FIG. 10 is a flow diagram illustrating an exemplary method for malware detection and mitigation, according to an aspect.

FIG. 11 is a block diagram of a network endpoint, according to one aspect.

FIG. 12 is a flow diagram of an exemplary method for threat prevention, according to one aspect.

FIG. 13 is a flow diagram of an exemplary method for exploit detection, according to one aspect.

FIG. 14 is a flow diagram of an exemplary method for malware detection, according to one aspect.

FIG. 15 is a flow diagram of an exemplary method for threat mitigation, according to one aspect.

FIG. 16 is a flow diagram of an exemplary method for threat remediation, according to one aspect.

FIG. 17 is a flow diagram of an exemplary method for threat forensics, according to one aspect.

FIG. 18 is a block diagram of a network endpoint showing endpoint protection engines, according to one aspect.

FIG. 19 is a flow diagram showing an overview of endpoint protection engine operation, according to one aspect.

FIG. 20 is a flow diagram of an exemplary method for advanced application control, according to one aspect.

FIG. 21 is a flow diagram of an exemplary method for real-time anti-ransomware, according to one aspect.

FIG. 22 is a flow diagram of an exemplary method for endpoint management, according to one aspect.

FIG. 23 is a block diagram illustrating an exemplary hardware architecture of a computing device.

FIG. 24 is a block diagram illustrating an exemplary logical architecture for a client device.

FIG. 25 is a block diagram showing an exemplary architectural arrangement of clients, servers, and external services.

FIG. 26 is another block diagram illustrating an exemplary hardware architecture of a computing device.

### DETAILED DESCRIPTION

The inventor has conceived, and reduced to practice, in various aspects of the invention, a next-generation enhanced comprehensive cybersecurity platform.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

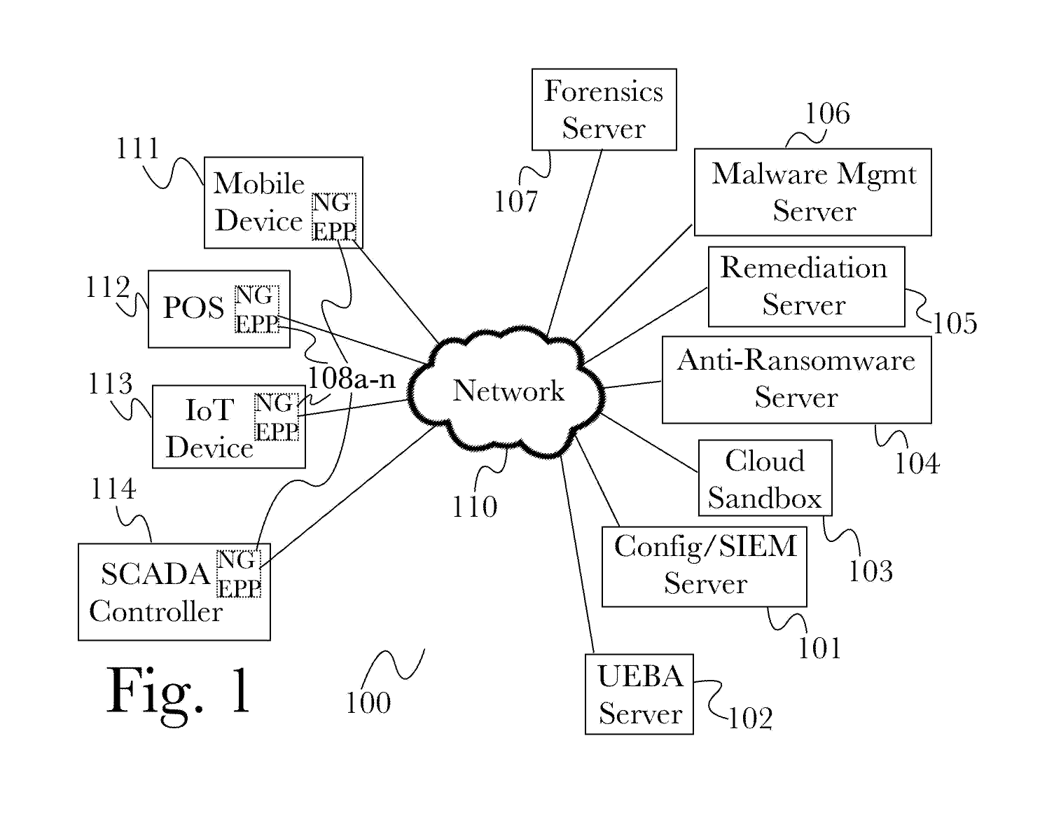

FIG. 1 is a system diagram of an exemplary arrangement 100 for a next-generation enhanced comprehensive cybersecurity platform, according to an aspect. According to the aspect, a plurality of next-generation endpoint protection (NGEPP) software agents 108a-n may be deployed on a variety of endpoint devices (generally, any network-capable computing device) such as mobile devices 111 (for example, including but not limited to smartphones, tablets, smartwatches, or other personal mobile computing devices), point of sale equipment 112, Internet-of-Things (IoT) devices 113 (for example, including but not limited to smart TVs, appliances, power outlets or lighting switches, smart light bulbs, or other connected devices), controllers such as SCADA controllers 114 for infrastructure components (such as power, communications, or other utilities), laptop and desktop personal computers or workstations (not shown for simplicity and clarity), and so forth. NGEPP agents 108a-n collect information from their respective host devices and provide it to various components of a next-generation enhanced comprehensive cybersecurity platform, and may receive information from the platform components via network 110. Potential threat events may be detected by NGEPPs, which may be configured to operate at an operating system kernel level or in the software user space on an endpoint device; threat responses may be initiated locally (at the endpoint device) and may be coordinated by one or more components of a next-generation enhanced comprehensive cybersecurity platform, via network 110.

Components used in a next-generation enhanced comprehensive cybersecurity platform may include, but are not limited to, one or more forensics servers 107 that may conduct remote forensic analysis of endpoints that have been or are suspected to have been attacked, one or more malware management servers 106 (that provide anti-virus services, whitelisting services, process hash databases, and the like), one or more remediation servers 105 that provide automated or semi-automated remediation actions (such as quarantine, file deletion, process stopping, and the like) in response to and remediation of hostile actions on one or more endpoint devices, one or more anti-ransomware servers 104 (that provide early warning, real-time intervention, and post-attach remediation services specific to ransomware attacks, including services such as secure central file backups for data protection, interception of improper user actions likely to inadvertently trigger a ransomware attack, and so forth), one or more cloud sandboxes 103 where files and services may be explored in a safe virtual environment, and one or more user- and entity-based analytics servers such as a security information and event management (SIEM) server 101 or a user and entity behavior analytics (UEBA) server 102, that provide in-depth analytics including enterprise baseline establishment and new threat detection, which may enable automated detection of, and response to, new zero-day exploits in the wild.

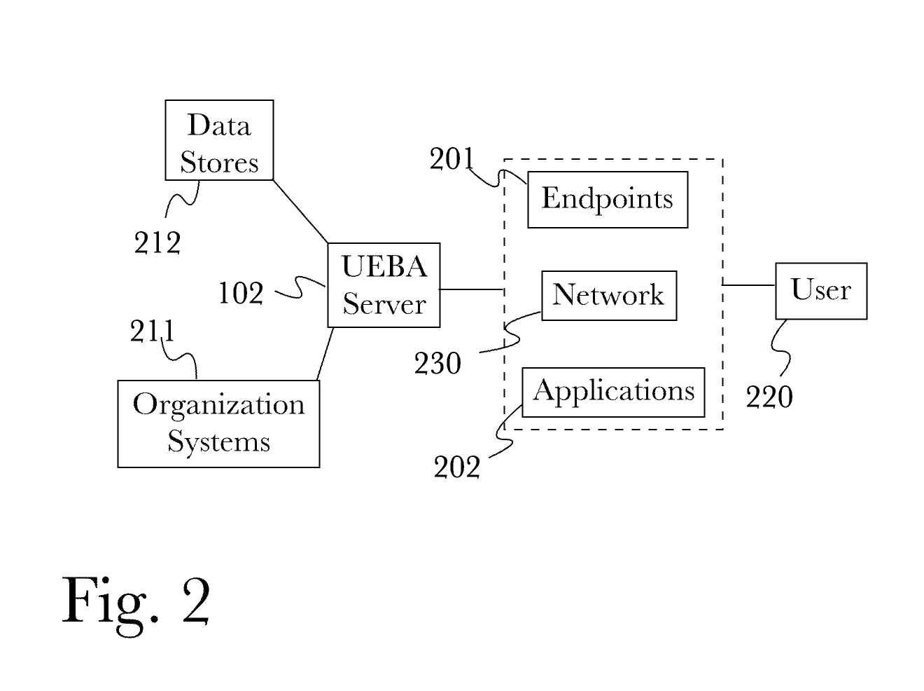

FIG. 2 is a diagram illustrating the function of a UEBA server 102, according to an aspect. According to the aspect, a UEBA server 102 may be used to provide an enhanced security information and event management (SIEM) solution, detecting malicious and abusive activity that might otherwise go unnoticed as well as consolidating and prioritizing security alerts from connected systems. UEBA server 102 may connect to a plurality of corporate systems 211 such as security systems (for example, firewalls, intrusion detection applications, user access logging, or other security-focused internal systems) as well as a plurality of data stores 212 such as databases, cloud-hosted repositories, or other data storage sources. UEBA server 102 may also be connected to a plurality of endpoints 201 that may each operate a NGEPP software agent (as described previously), as well as a plurality of internal applications 202 such as cloud-based, mobile, or other internal applications for users within the enterprise. These endpoints enable monitoring of user activities as they use devices, access information and applications, and interact with and move between and within various systems and components of an enterprise infrastructure.

UEBA server 102 may use information from these various connected systems and resources to rapidly detect and analyze malicious or abusive behavior, by recognizing known behavior and information patterns that may identify an activity as “safe” or “unsafe” (for example, known malicious file signatures, or known routine user behaviors). User activities may be monitored and evaluated beyond an initial login, and include user movements, access to organizational assets and the contexts within which access occurs. Users 220 may be grouped according to their activities into peer groups, for example using directory groupings and human resources information as a starting point and then monitoring user activity over time. This tracking and organization may then be used to correlate user and other entity activities and behaviors, enabling the detection of anomalies using statistical models and machine learning.

Notifications may be provided to a user 220 via an appropriate channel (such as a push notification to their mobile device via a network 230, or a notification within an application 202 for viewing), and may be prioritized by correlating and consolidating alerts from existing systems (for example, alerts may be triggered by intrusion detection software or a firewall). Alerts may then be responded to by user 220, streamlining alert and incident investigations by reducing the time and number of staff required to investigate those alerts. Since the underlying data for the correlated alerts is typically readily available, investigators can easily look across organizational assets and entities linked to suspect behavior.

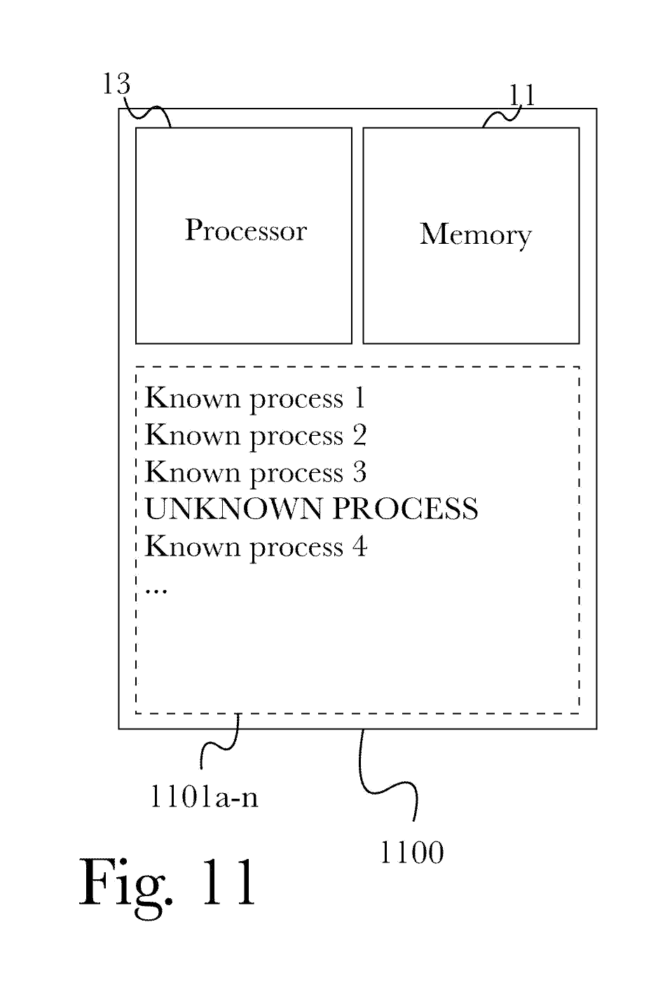

FIG. 11 is a block diagram of an exemplary network endpoint 1100, according to one aspect. A network endpoint 1100, such as (for example, including but not limited to) a mobile device or IoT sensor, may operate a NGEPP agent 108a-n to perform host-based intrusion prevention and detection by monitoring files and processes 1101a-n operating on the processor 13 or stored in the memory 11 of the endpoint device 1100. The NGEPP agent 108a-n may control whether a particular piece of executable code is allowed to execute or perform operations, offering options to a user via notification prompts to select a desired action when suspicious code attempts to run or perform system behaviors. A user may choose to permit the activity (allowing the code to run normally), deny the activity and block the code operation entirely, or “sandbox” the activity. When sandboxing an activity, the suspicious process or file may be sent to a cloud-based malware management server 106, that may then “explode the payload” of the code in question within a cloud sandbox 103, clicking links and accessing data within the code to simulate user interaction for signature-less examination, while observing the results in a safe environment (for example, clicking on links or opening files that may contain malware). A remediation server 105 may then provide instruction to the NGEPP agent 108a-n for handling any threats found, such as halting a process or quarantining or deleting unsafe files.

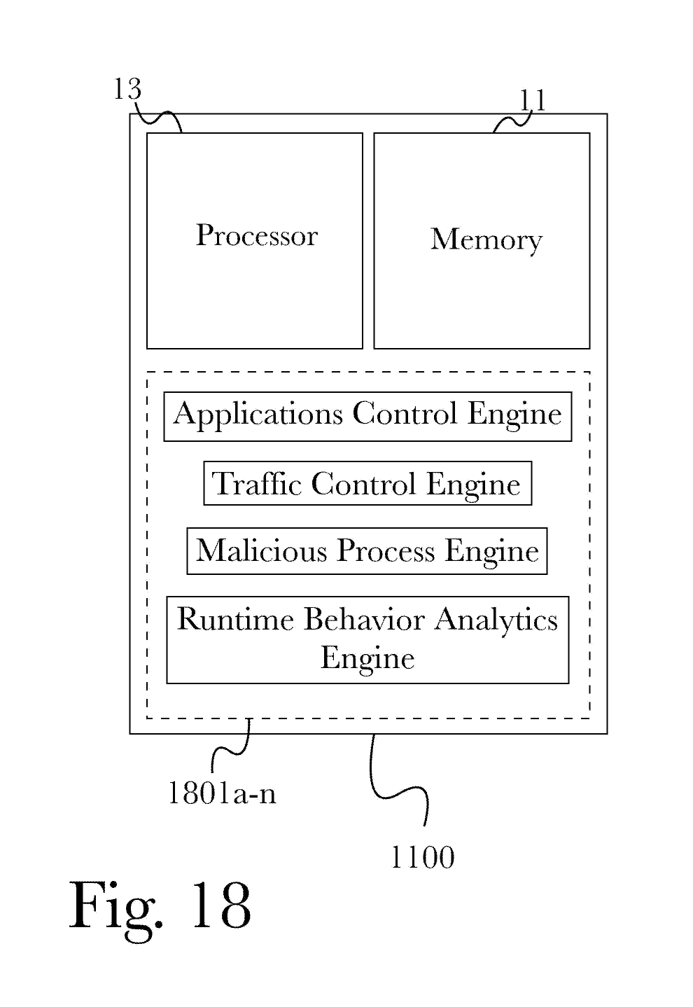

FIG. 18 is a block diagram of a network endpoint 1100 showing a plurality of endpoint protection engines 1801a-n, according to one aspect. According to the aspect, a plurality of endpoint protection engines 1801a-n may operate on a network endpoint 1100 to provide a number of protection modes for the endpoint as well as to provide advanced functionality through interaction between individual protection engines or endpoints. For example, an applications control engine may be used to protect against zero-day malware or prevent unauthorized apps from running or performing restricted operations on an endpoint 1100, such as accessing device information to which an app shouldn't have access, while a traffic control engine may be used to protect against zero-day vulnerabilities or exploits such as those that might malicious activities on the endpoint or network such as sending malicious network packets, performing denial-of-service (DOS) attacks, or any other malicious activities. A malicious process engine may be used to provide global threat and reputation intelligence, for example through coordination with other protected network endpoints 1100 or a remote or cloud-based threat intelligence service such as one that may be provided by a UEBA server 102. A runtime behavior analytics engine may be used to protect against ransomware, for example by identifying and halting malicious processes, preventing an initial attack vector for ransomware by preventing the process from taking device functionality or information hostage for exploitation.

### Detailed Description of Exemplary Aspects

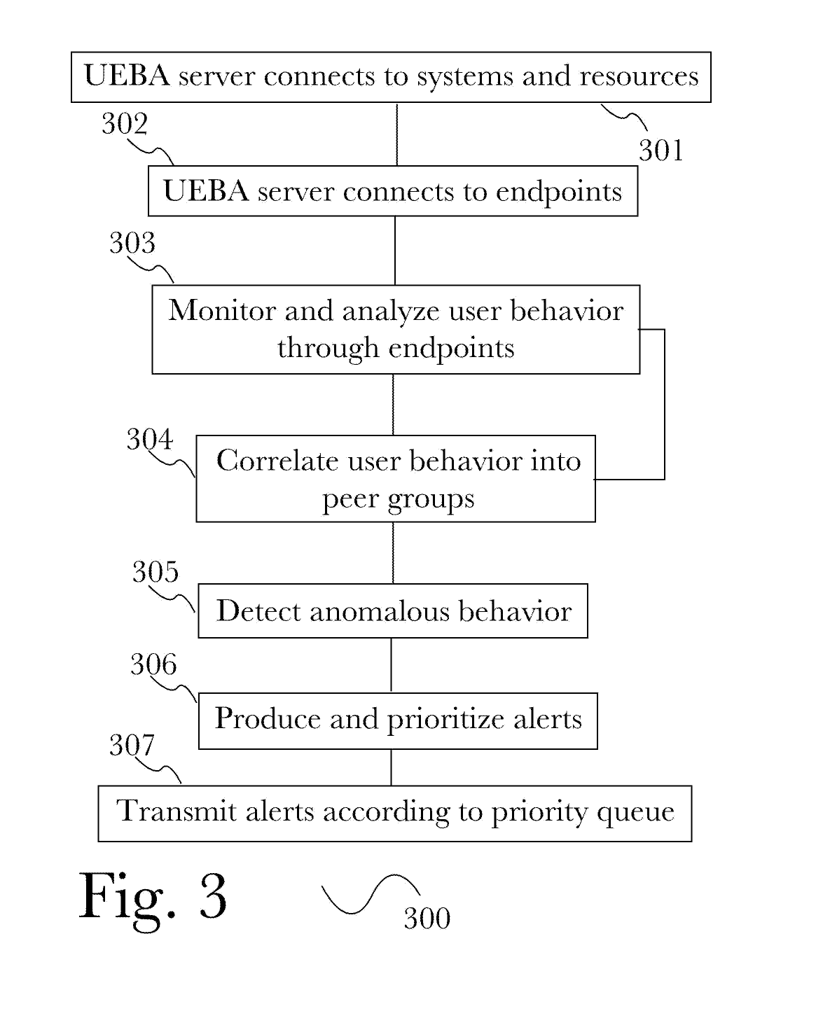

FIG. 3 is a flow diagram of an exemplary method 300 for using a UEBA server 102 to provide enhanced SIEM, according to an aspect. In an initial step 301, a UEBA server 102 may connect to a number of systems and resources such as (for example, including but not limited to) databases, security systems, user directories, or other enterprise resources. In a next step 302, UEBA server 102 may further connect to a plurality of network endpoints such as user devices or enterprise applications. While connected to endpoints and resources, UEBA server 102 may then monitor and analyze user behavior 303 through the connections, forming peer groups 304 and correlating user activity using machine learning 305 to expose anomalies. When a potential threat is detected 305, UEBA server 102 may then produce an alert 306, while receiving and prioritizing any alerts produced by connected systems to form a priority queue of all alerts. Alerts may then 307 be transmitted according to the order in the priority queue, for example sending specific alerts to specific users or sending alerts via specific communication channels (such as email, SMS, push notification, or in-app notifications) or with specific timing (such as sending a first alert, waiting a predetermined time based on the priority queue, then if no action was taken sending a second alert).

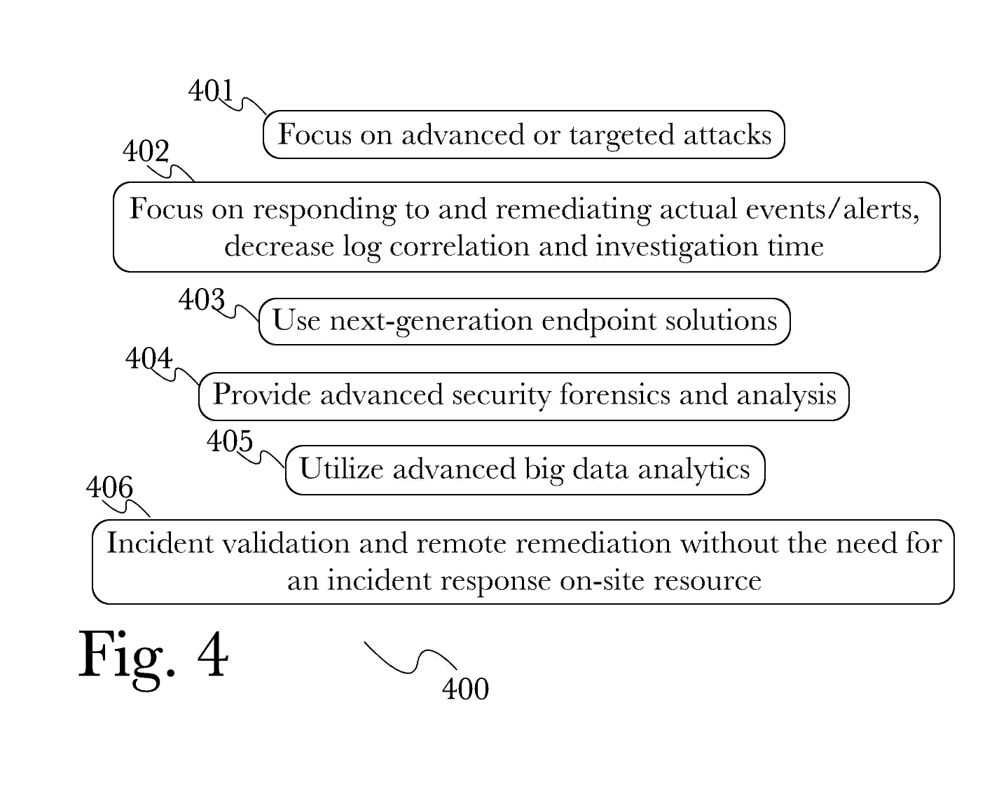

FIG. 4 is a table 400 illustrating several benefits of using a UEBA server 102 to provide machine-learning-driven enhanced SIEM, according to an aspect. According to the aspect, a UEBA server 102 may be used to provide advanced analysis of user behavior and events as well as prioritized notification curation, as described previously (with reference to FIGS. 1-3). This enables security personnel to focus on advanced or targeted attacks 401, allowing security to address the highest-priority issues first without getting distracted or delayed by lesser concerns. Prioritized notifications enable 402 personnel to focus on responding to, and remediating, actual events rather than spending time on log curation and investigation to determine whether an attack actually occurred or to determine the extent of the damage. UEBA server 102 uses connections with a plurality of NGEPP software agents 108a-n to provide monitoring 403 of user behavior through security endpoints such as enterprise resources (applications, systems, etc.) and user devices (such as, for example, personal computers or smartphones). This enables UEBA server 102 to provide advanced security forensics and analysis 404 by tracking detailed user behavior across resources and systems, and by using big-data analytics 405 anomalous behavior can be automatically identified for validation and remote remediation 406 without needing a dedicated onsite incident response team.

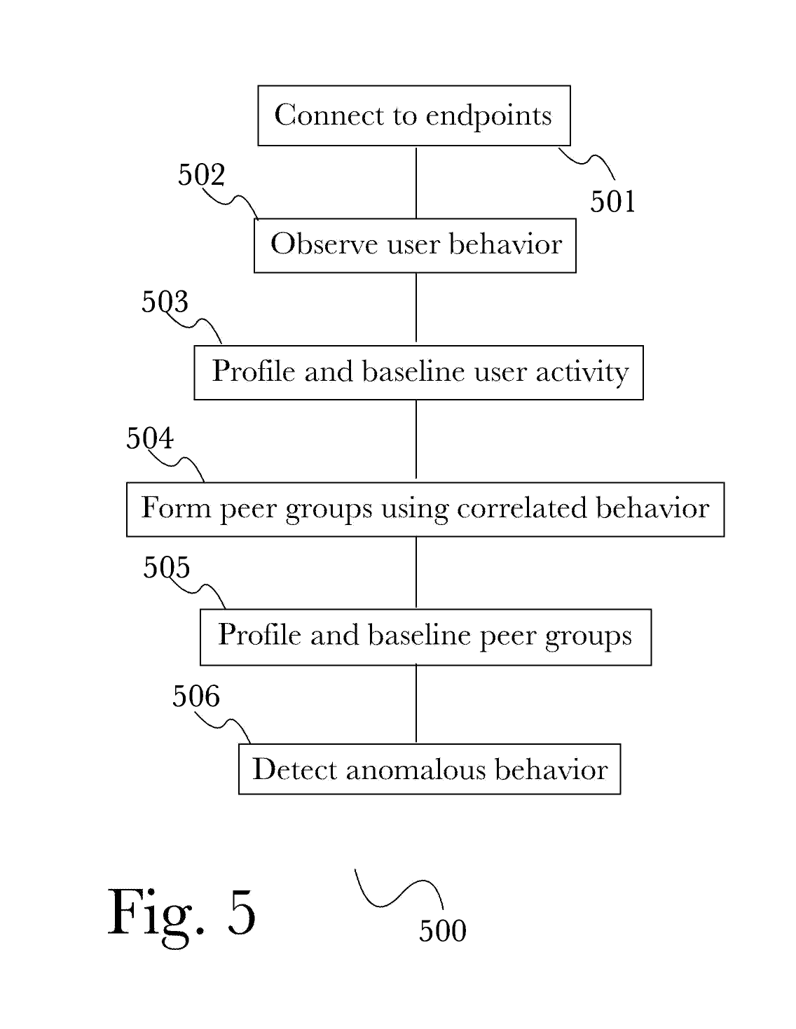

FIG. 5 is a flow diagram illustrating an exemplary method 500 for user behavior analytics using a UEBA server 102, according to an aspect. According to the aspect, a UEBA server 102 may first connect to a plurality of endpoints 501 such as user devices (for example, smartphones or personal computers), corporate devices such as servers or databases, or enterprise applications such as internal applications and user directories. User behavior may then be observed 502 as users interact with and move between these endpoints, allowing UEBA server 102 to use machine learning to profile user activity 503 and form a baseline of what may constitute “normal” activity for any given user or user group. Behavior may then be used to correlate and group users into peer groups 504, or logical groupings of users with similar behavior profiles (that may or may not have any real association in the physical world or in a user directory), and these peer groups may be similarly profiled and baselined 505. These behavior profiles and baselines may then be used to identify anomalous behavior 506 as it occurs, for example by using machine learning to compare behavior to statistical models based on the known baselines for the involved parties (individual users, user groups, or peer groups).

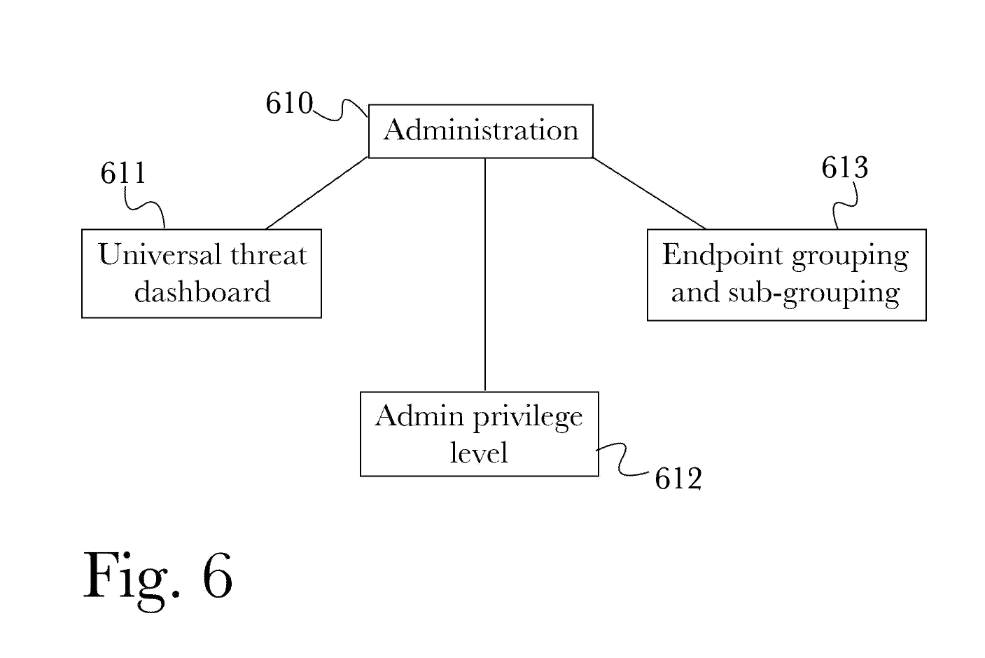

FIG. 6 is a block diagram of an exemplary logical arrangement of administration functions 610 provided by a UEBA server 102, according to an aspect. According to the aspect, a UEBA server 102 may provide a number of administration functions 610 for security personnel to use when handling threats, including multiple administrator privilege roles 612 such as (for example) read-only administration or full administration, to enable fine-grained control over who can perform what operations. For example, a read-only administrator may be able to view threat reports and security logs, but cannot make policy or directory changes directly (which must then be performed by a full administrator), enabling a hierarchy of administration for more efficient response management. A universal threat dashboard 611 may be provided, to present a unified view for all connected components and systems and their respective alerts and status for easy viewing by personnel. Endpoint grouping and sub-grouping 613 may be used to form groups of security endpoints such as (for example, including but not limited to) enterprise applications, user devices, or internal resources such as servers or databases. This enables grouping of endpoints in a manner similar to peer grouping for users, to enhance machine learning and other operations of UEBA server 102.

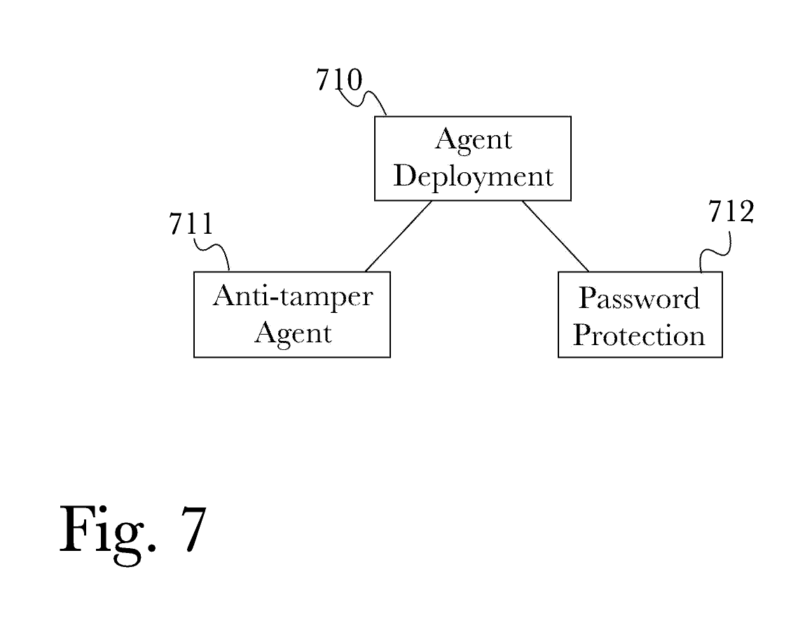

FIG. 7 is a block diagram of an exemplary logical arrangement of deployment functions 710 for NGEPP software agents 108a-n, according to an aspect. According to the aspect, UEBA server 102 may provide a number of deployment functions 710 to assist with deploying NGEPP software agents 108a-n to devices. An anti-tampering agent 711 may be provided either as an optional add-on feature or as an embedded component of an NGEPP software agent 108a-n, that may prevent a user from interfering with the operation of the NGEPP software agent 108a-n (such as attempting to manually stop the process from running). Password protection may be provided 712 for installation or uninstallation of an NGEPP software agent 108a-n, again to prevent unwanted tampering such as unauthorized uninstallation of a user's agent or installation on unauthorized devices (for example, in an attempted spoofing attack where a device is used to impersonate actual user behavior).

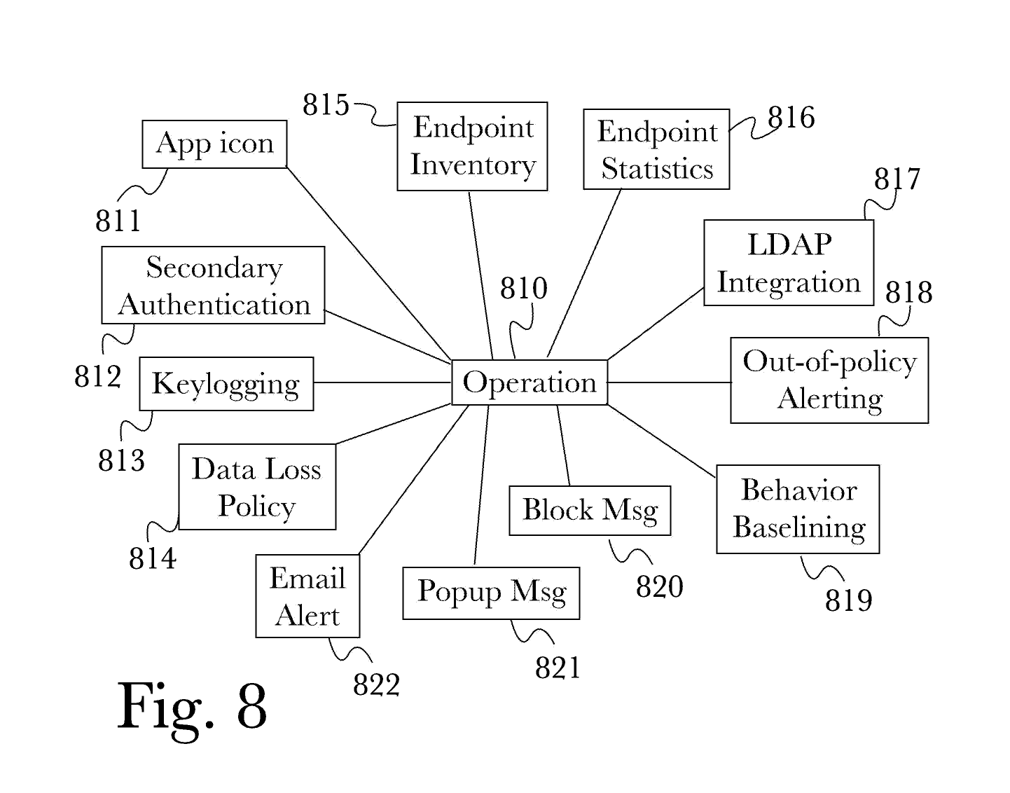

FIG. 8 is a block diagram of an exemplary logical arrangement of operations 810 provided by an NGEPP software agent 108a-n, according to an aspect. According to the aspect, an NGEPP software agent 108a-n may provide a wide variety of operations 810 on a host endpoint, such as a user's smartphone or personal computer, and some or all of these operations may be controlled by security personnel remotely, and may be transparent to a user. An application icon 811 may be configured to hide or show an icon for the NGEPP software agent 108a-n, either on a device's home screen or in an application manager such as a dock or system tray (according to the design or configuration of the hosting endpoint device). A secondary authentication layer 812 may be used to accommodate shared accounts, for example for a device with multi-tenancy such as a desktop workstation or a shared device. This secondary authentication 812 enables per-user tracking within a single endpoint, in addition to per-endpoint tracking already provided. Keylogging 813 may be used to track keystrokes on a device or within an application, for example to verify the nature of a user's activities or to ensure sensitive information is being handled appropriately. A data loss policy 814 may be used to enforce loss prevention policies on removable storage devices, such as to prevent copying sensitive files or contents onto removable storage to prevent data leaks.

An endpoint inventory 815 may be used to index the hardware and software of endpoints for easier management, and endpoint statistics 816 may show counts for recorded sessions, account logins, or other activities both per-endpoint and per-user within a particular endpoint. Integration with a lightweight directory access protocol (LDAP) system 817 may be used to integrate with an existing user directory, quickly incorporating existing user account information and organizational structure as well as authorization and authentication information from an existing LDAP setup. Out-of-policy alerts 818 may be produced when a user or endpoint violates a policy rule, such as an unauthorized configuration or activity. User behavior may be logged and used to form a baseline 819 of normal activity that may then be used to identify anomalous activity (as described previously, referring to FIGS. 3-5). A block message 820 may be used to block out a device or application when a policy is violated, preventing further unauthorized activity, or a popup message 821 may be used to display an indicator on-screen without impacting activity (for example, for lesser violations or warnings). For severe violations, an email alert 822 may be triggered and sent to an administrator to notify them of the out-of-policy violation.

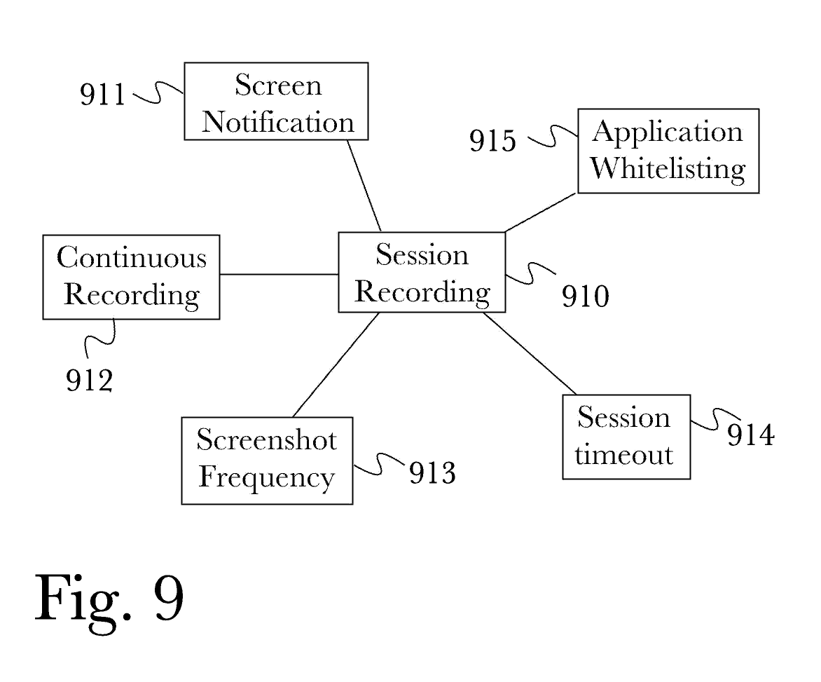

FIG. 9 is a block diagram of an exemplary logical arrangement of recording functions 910 provided by an NGEPP software agent 108a-n, according to an aspect. According to the aspect, an NGEPP software agent 108a-n may perform a variety of session recording functions 910 to record activity on a host endpoint. During recording, a screen notification 911 may optionally be shown to alert a user, such as a banner notification at the top of the screen that may persist and be visible regardless of the activity or applications open on the device, or a temporary popup notification might be shown to alert the user and then hide, allowing unobstructed use of the device or application. Continuous recording 912 may be used to record endpoint session activity even after a period of inactivity from a user, for example to continue recording if the user is idle temporarily but activity may still be processing on the endpoint. Screenshots may be captured with variable frequency 913, for example to capture high-frequency still images rather than record video of session activity, such as to conserve resources (both processing resources on the endpoint itself as well as storage space for stored recordings). A configurable session timeout 914 may be used to enable session recording to pause or end after a defined period of inactivity, for example so that recording will capture brief periods of inactivity but stop after a threshold is met (such as several minutes of inactivity, as might indicate that the user is no longer using the endpoint). Application whitelisting 915 may be used to enable per-application recording, selectively omitting configured applications from recording or alternately selecting only specific applications to be recorded rather than simply recording all activity on a device, as might be inappropriate in an enterprise with a bring-your-own-device (BYOD) policy, where users may be using personal devices for work.

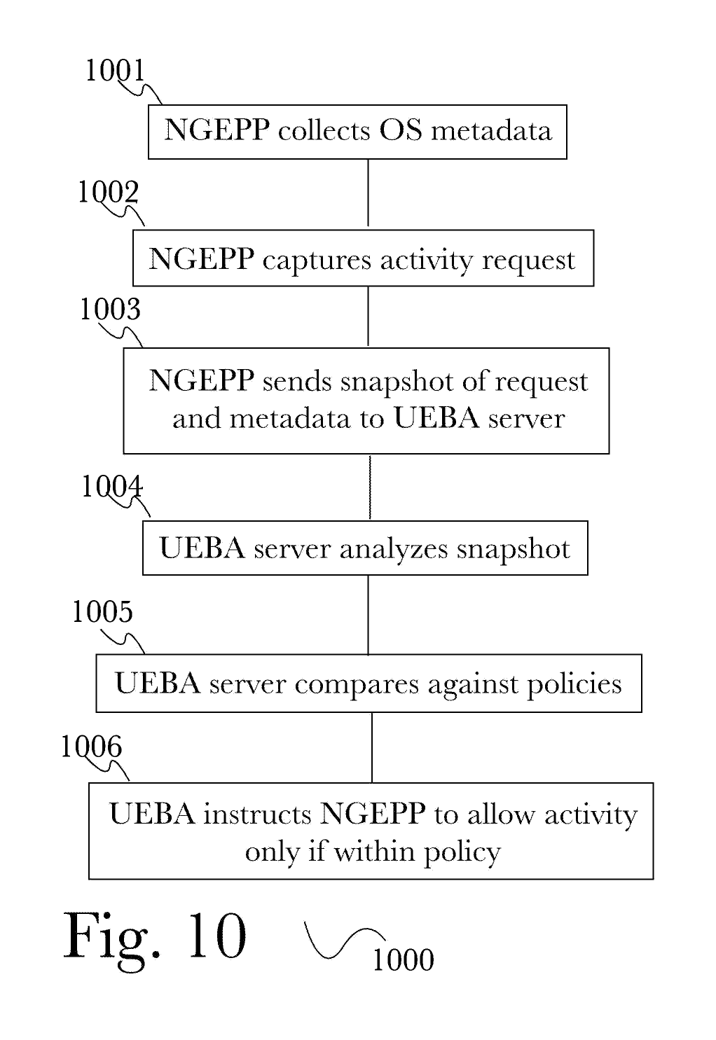

FIG. 10 is a flow diagram illustrating an exemplary method 1000 for malware detection and mitigation, according to an aspect. According to the aspect, in an initial step 1001 an NGEPP software agent 108a-n may collect operating system metadata (such as vendor, version, or other such details) for the operating system of the endpoint device on which it is operating. When an activity request is captured 1002 such as an attempt to open a file or perform an action, a snapshot of the request information may be sent 1003 to a UEBA server 102 along with the previously-collected OS metadata. Upon receipt, the snapshot and metadata may be analyzed 1004 by UEBA server 102 and compared against policy rules 1005 to determine whether the activity is “safe” and should be allowed, or if it should be blocked. Only activities that fall within the acceptable policy definitions may be allowed, and the UEBA server 102 directs the NGEPP software agent 108a-n to handle the activity accordingly 1006.

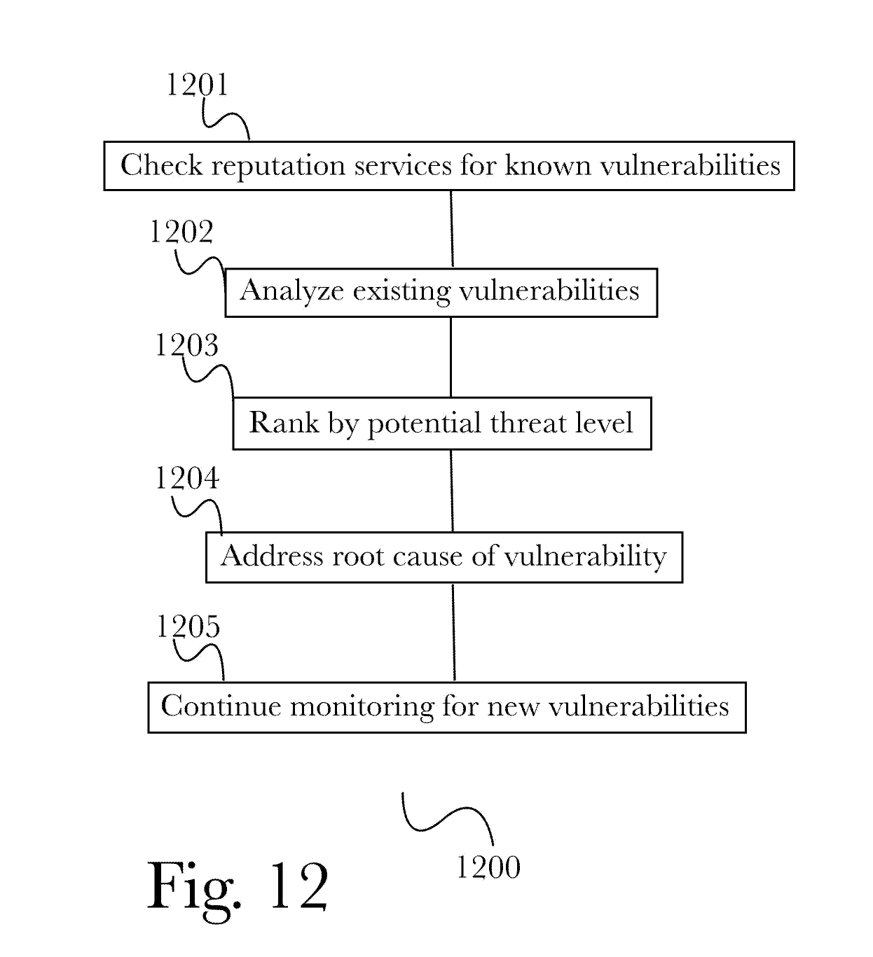

FIG. 12 is a flow diagram of an exemplary method 1200 for threat prevention, according to one aspect. Vulnerability management is used to preemptively defend against the exploitation of vulnerabilities in company applications, software and networks. Implementing effective vulnerability or patch management tools can significantly reduce potential attack surface, keeping users safe from data breaches and theft. According to the aspect, a vulnerability management method 1200 may comprise the steps of first 1201 discovering existing vulnerabilities using any of a number of cloud-based reputation services rather than a single vulnerability database, and then 1202 analyzing vulnerabilities and ranking them 1203 according to potential threat level. This ranked threat list may then be used to mitigate 1204 the root cause of a vulnerability, and maintain security through ongoing testing and security monitoring 1205.

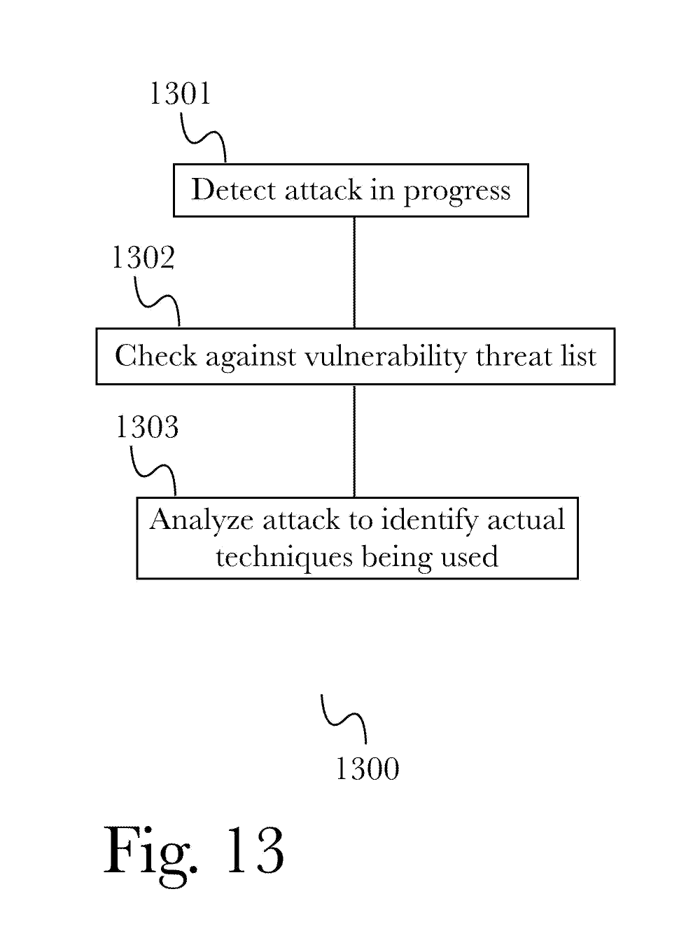

FIG. 13 is a flow diagram of an exemplary method 1300 for exploit detection, according to one aspect. Using exploits to take advantage of code-level vulnerabilities is a sophisticated technique used by attackers to breach systems and execute malware, and “drive-by” software downloads are a common vector for carrying out such attacks. According to the aspect, an exploit detection method 1300 may provide protection against both application and memory-based exploits, by first 1301 detecting an attack and then 1302 checking against a known vulnerability threat list (as described previously in FIG. 12) to determine the details of the particular attack. The attack may then be analyzed 1303 in place on the device being attacked to identify the technique that is actually being used by the attack (for example, including but not limited to heap spraying, stack pivots, ROP attacks, or memory permission modifications).

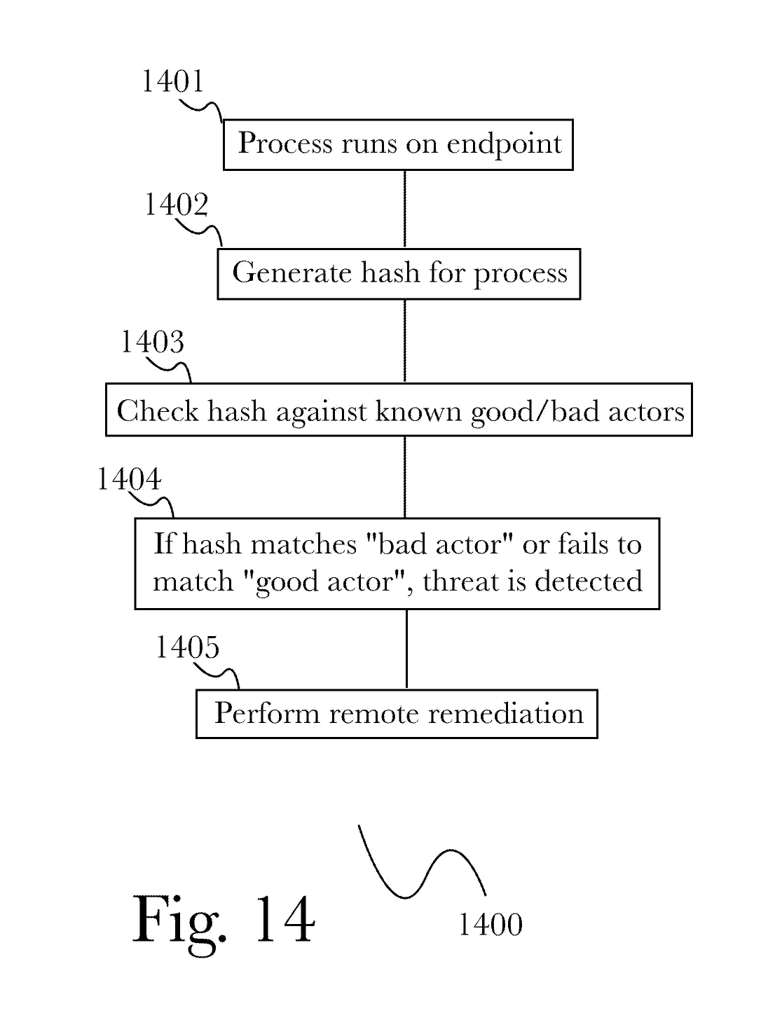

FIG. 14 is a flow diagram of an exemplary method 1400 for malware detection, according to one aspect. According to the aspect, a global database may comprise a whitelist of known files or processes and a blacklist of known “bad actors”, against which files and processes may be checked for threat detection. When a process runs on an endpoint 1401, a hash may be generated using a hashing algorithm 1402 to produce a unique and reversible hash representing that specific process, which may then be checked against the global database 1403. If a process has been tampered with or falsified, the hash will change and no longer match a previous entry in the whitelist, generating a threat detection 1404. When a threat is found, remote remediation may be performed 1405 by a remediation server 105 such as (for example) terminating a process or erasing a file without executing or accessing the contents, preventing any harm. This may also be performed using localized or client-specific whitelists or blacklists, for example for processes or files unique or proprietary to a particular corporation or for custom-tailored threat characteristics (for example, some users may have different considerations of what constitutes a threat).

To build a threat detection database, a baseline may be built over a set timeframe, wherein files and processes are hashed and added to a whitelist to automatically generate a whitelist for “normal operation” against which future hashes may be checked. If a new file or process is detected that is not on a local whitelist, it may be checked against a global whitelist to see if (for example) it is a legitimate process that simply did not run during the baselining process and thus was missed, or if it is indeed a malicious process. Unknown processes may generate an alert as described previously, prompting a user or administrator to manually allow, deny, or sandbox the potential threat. When sandboxed suspicious files or processes are determined to have carried an actual malicious payload, they may be added to a blacklist, enabling intelligent adaptation to new threats over time. This approach has a low occurrence of false results (whether positive or negative), and enables rapid detection of “zero-day” threats through the use of process white- and blacklisting.

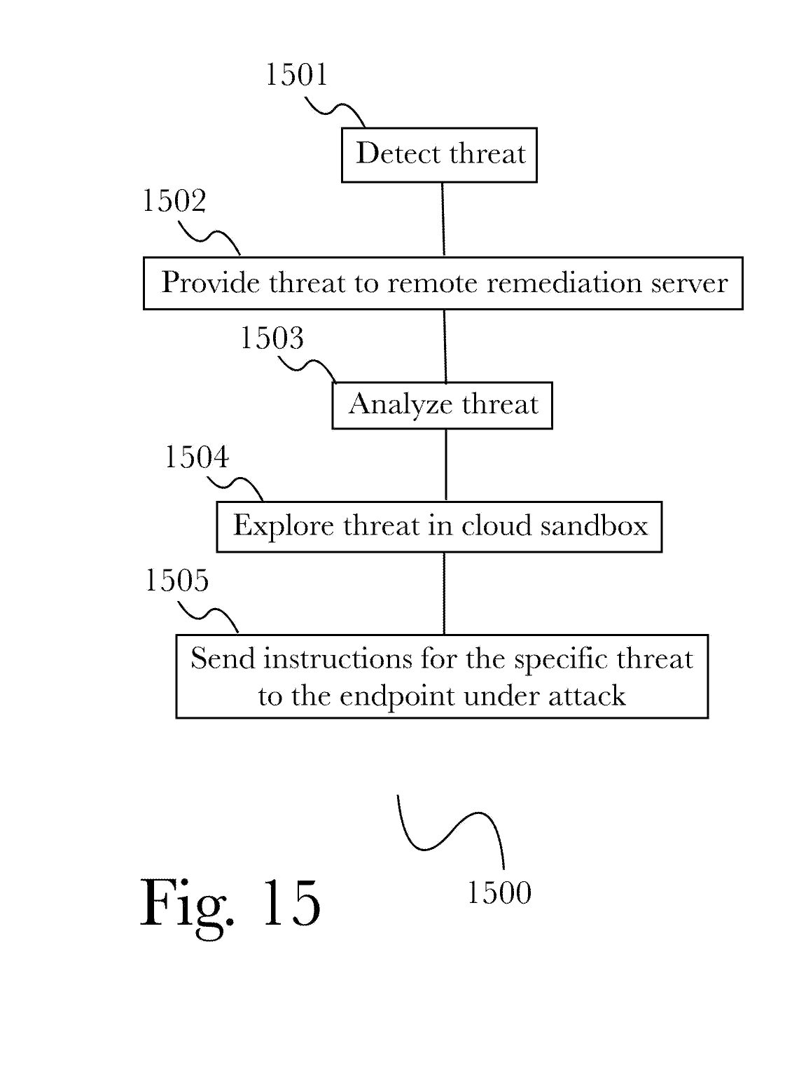

FIG. 15 is a flow diagram of an exemplary method 1500 for threat mitigation, according to one aspect. Detecting a threat is a vital part of any protection process, but is not sufficient alone. When a threat is detected 1501, it may be provided 1502 to a remediation server 105 to be analyzed 1503. Remediation server 105 may then address the threat in a suitable manner 1504, for example by using a cloud sandbox 107 to fully explore the threat in a safe environment where it cannot do harm. Remediation server 105 may then send instructions to the endpoint under attack 1505, directing it to perform actions to remediate the threat such as (for example, including but not limited to) quarantining or removing files or processes, shutting down a running process, or even shutting down the endpoint device itself if necessary. This provides an approach to threat mitigation that is flexible, addressing each threat on an individual basis rather than relying on policies that may not adequately apply to a particular attack, and it allows precise and effective mitigation based on the specific attack in progress by fully analyzing it and selecting a course of action that is most appropriate for that threat.

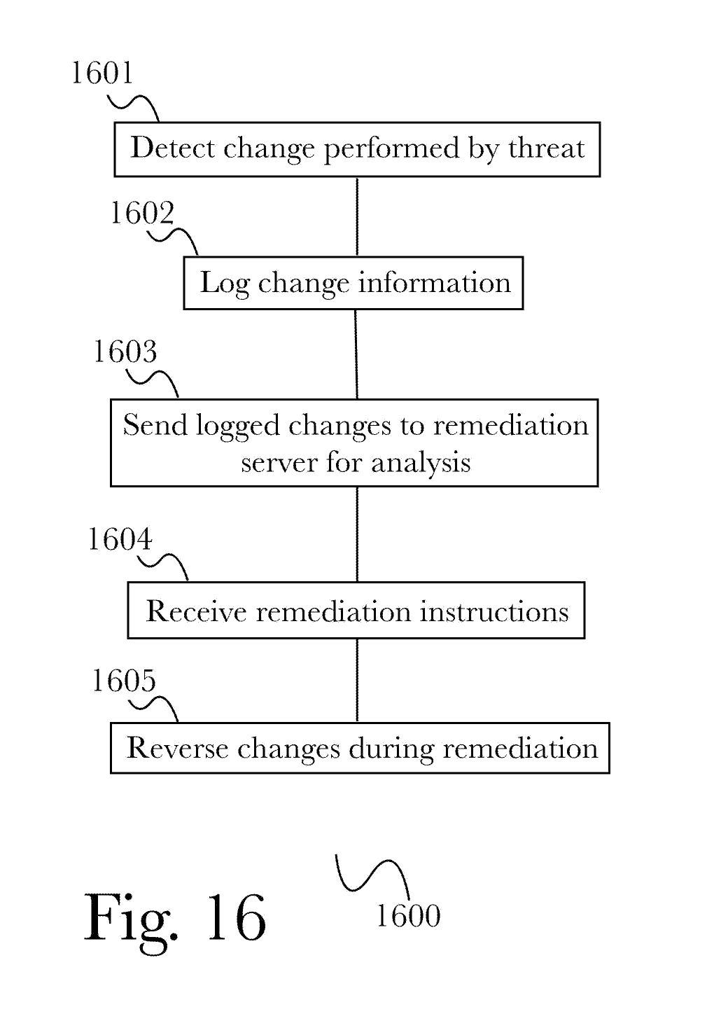

FIG. 16 is a flow diagram of an exemplary method 1600 for threat remediation, according to one aspect. During execution of an attack, malware often creates, modifies, or deletes system file or registry resources, or changes configuration settings. To handle these effects of an attack, a NGEPP agent 108a-n may first detect a change 1601, and then as part of a remediation process log the changes 1602 and send 1603 the log information to a remediation server 105 for use in analyzing the threat. When remediation instructions are received 1604, part of a remediation process then includes reversing the changes performed by the threat 1605, returning any files or resources to their original state.

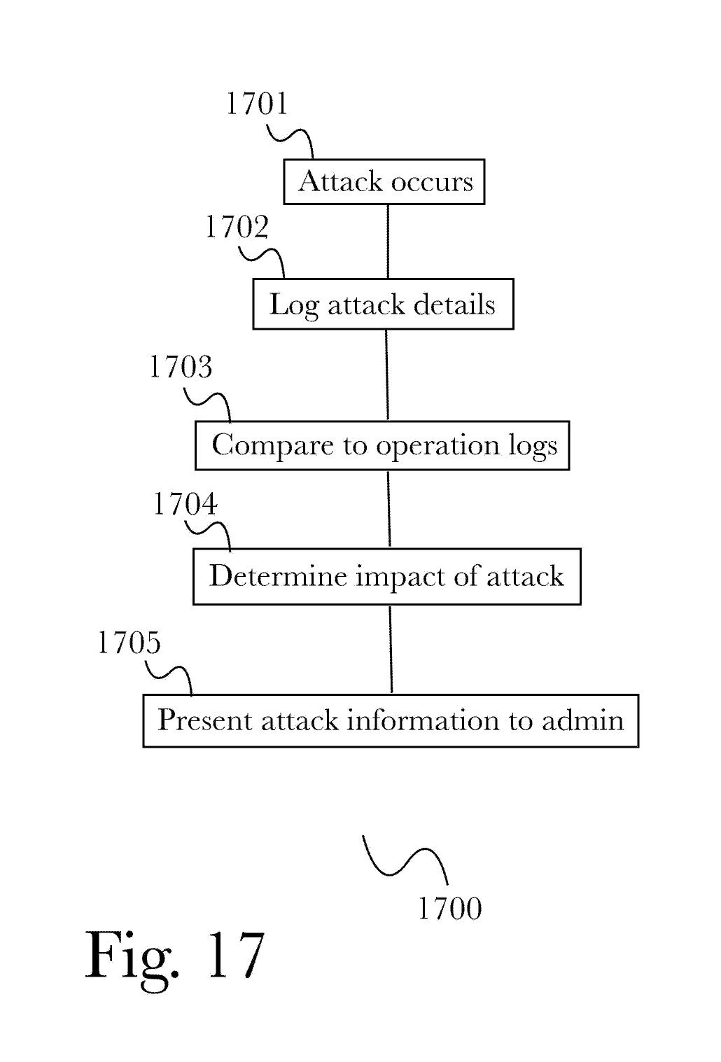

FIG. 17 is a flow diagram of an exemplary method 1700 for threat forensics, according to one aspect. A NGEPP agent 108a-n may be used to provide real-time forensics after an attack (whether successful or not), to provide clear and timely visibility into malicious activity that may have taken place on an endpoint. According to the aspect, when an attack occurs 1701, a NGEPP agent 108a-n may log the details of the attack 1702 such as the threat level and any changes made (as described previously, referring to FIGS. 12 and 16). This may then be compared against logs of running processes and open files 1703 to determine what changes took place and what the potential impact may be of a particular attack 1704, to form a report that may then be provided to administrators via the network or optionally via a reporting view in an administration interface 1705.

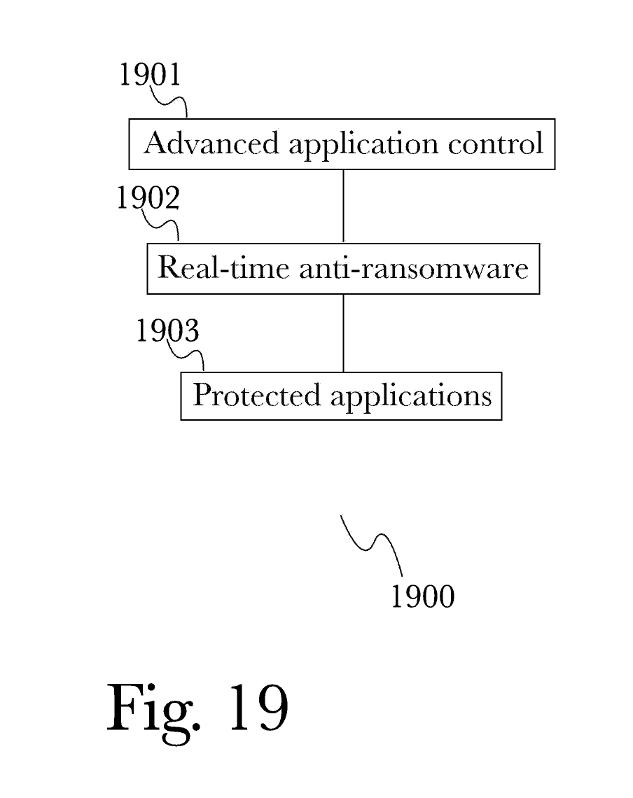

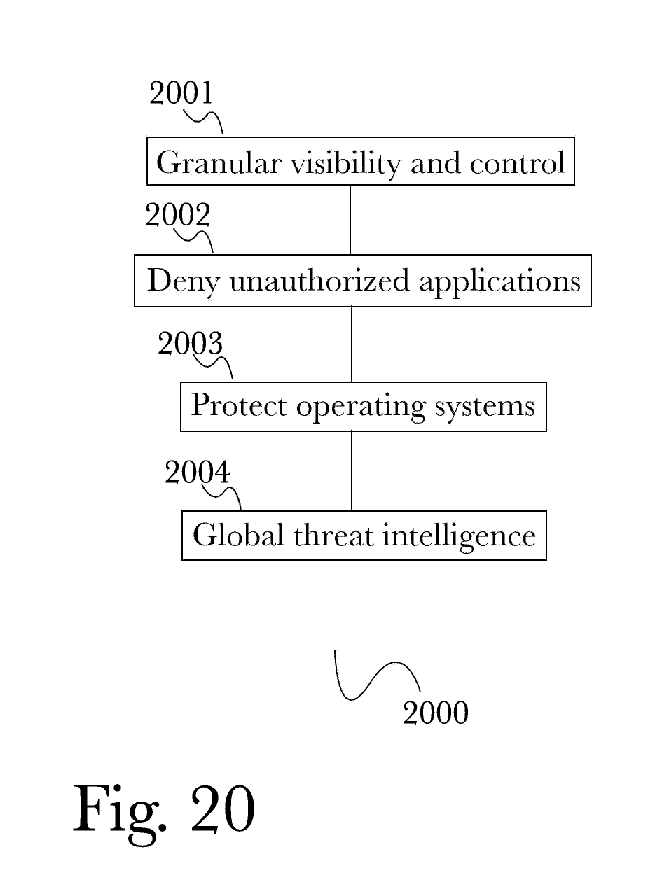

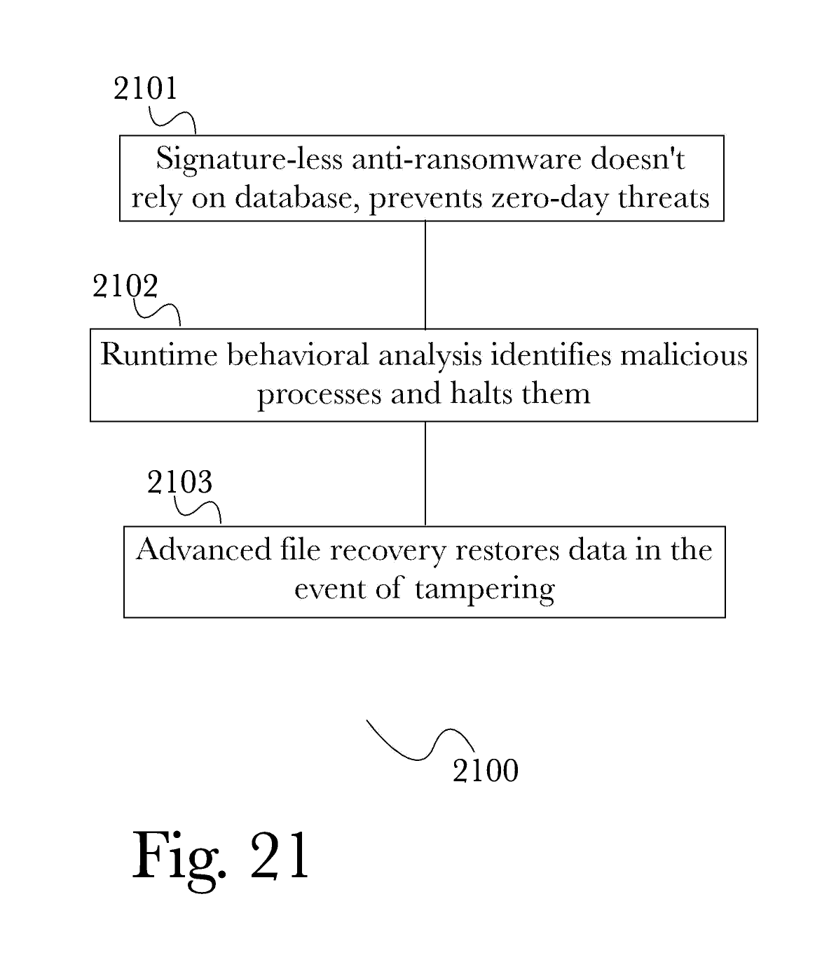

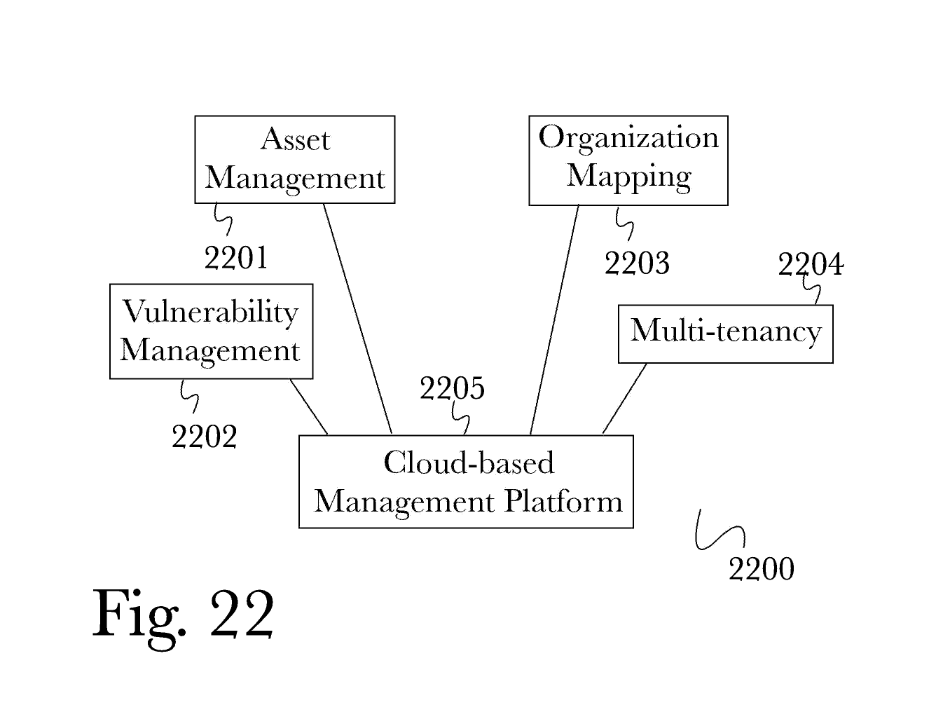

FIG. 19 is a flow diagram showing an overview 1900 of endpoint protection engine operation, according to one aspect. According to the aspect, endpoint protection 1900 may comprise a suite of protection engines 1801a-n that provide functions including (but not necessarily limited to) advanced application control 1901 (described in greater detail below, with reference to FIG. 20), real-time anti-ransomware protection 1902 (described in greater detail below, with reference to FIG. 21), and the ability to run protected applications 1903 on a network endpoint 1100 (described in greater detail below, with reference to FIG. 22).

FIG. 20 is a flow diagram of an exemplary method 2000 for advanced application control 1901, according to one aspect. According to the aspect, advanced application control 1901 may comprise a number of steps 2000, which may be executed in any sequence or combination and of which any number may be omitted or new steps added as appropriate for a particular endpoint 1100, for example in an endpoint without a full software operating system step 2003 may be omitted. Advanced application control may provide granular visibility and control 2001 to give administrators complete awareness and control of applications operating on a network endpoint 1100, enabling fine-tuning of operation as well as manual oversight when desirable. Granular policies may be applied, so that applications may be protected against a variety of threats such as (for example, including but not limited to) file-less attacks, document-based attacks, or software exploits such as application-specific vulnerabilities. Unauthorized applications may be automatically denied 2002 to prevent zero-day malware execution, for example any application not expressly allowed by a whitelist may be prevented from execution and thus prevent new malware from operating regardless of whether it is previously-known. Operating systems may be protected 2003, hardening them against vulnerabilities to provide protection beyond what is offered by official support channels and extend service life beyond in order to maintain compatibility within a network. For example, as systems age they may continue using older operating systems to maintain compatibility without risking exposure to security vulnerabilities due to lack of official support. Global threat intelligence 2004 may be utilized to establish application reputation and automatically apply security policies in real-time at any level of granularity, as well as to protect applications against known vulnerabilities and maintain granular policies over time.

FIG. 21 is a flow diagram of an exemplary method 2100 for real-time anti-ransomware 1902, according to one aspect. According to the aspect, anti-ransomware 1902 may comprise a number of steps 2100, which may be executed in any sequence or combination and of which any number may be omitted or new steps added as appropriate for a particular endpoint 1100. Signature-less anti-ransomware may be utilized 2101, to identify and prevent ransomware without relying on malware signatures (which may miss zero-day attacks as they are not in the signature database yet). Runtime behavioral analysis 2102 may be used to detect and block ransomware from executing by identifying malicious processes or applications in real-time, thereby preventing any device information or capabilities from being taken hostage by the malware (for example, by preventing a process from encrypting data). Advanced file recovery 2103 may then be used to restore any data that may have been encrypted or altered prior to halting the malicious process or application, maintaining normal operation and data integrity while denying bad actors.

FIG. 22 is a block diagram of an exemplary system 2200 for endpoint management, according to one aspect. According to the aspect, endpoint management may comprise a number of features, including but not limited to asset management 2201, vulnerability management 2202, organization mapping 2203, multi-tenancy 2204, and a cloud-based management platform 2205. Asset management 2201 may provide an organization with full visibility and control including, for example, individual endpoint status, application status such as applications currently running on one or more endpoints or applications that have been identified as malicious, user or location information, as well as the ability to apply policies at a granular level throughout the organization. Vulnerability management 2202 may be used to provide information about the state of an organization's security, for example by identifying and prioritizing risks across the organization to enable administrators to discover vulnerabilities without relying on performance-impacting threat scanners. Organization mapping 2203 may be used to produce graphical maps and visualizations for an organization, including infrastructure nodes, network endpoints, regions, locations, departments, or other organizational methods (for example, non-hierarchical organizational models). Multi-tenancy 2204 enables support for users with multiple roles or privileges, enabling an organization to provision their environments precisely with full granular control and visibility of user accounts including (for example, not limited to) roles, privileges, or access requirements. A cloud-based management platform 2205 provides centralized management of policies and services, enabling rapid deployment of changes and enabling administrators to easily isolate threats such as malicious applications or compromised devices in real-time.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

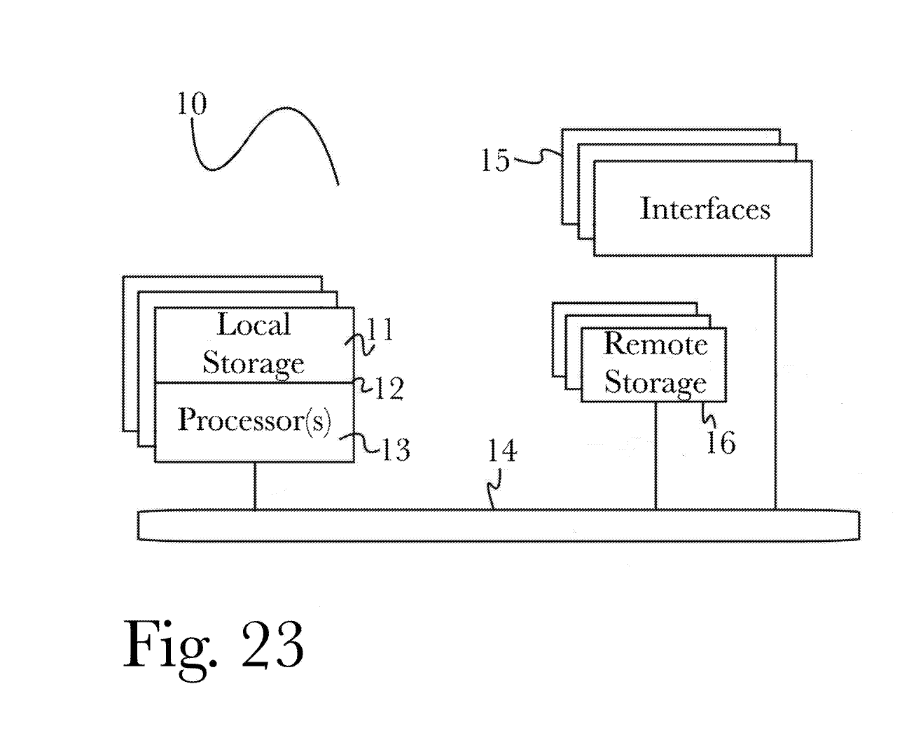

Referring now to FIG. 23, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 23 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

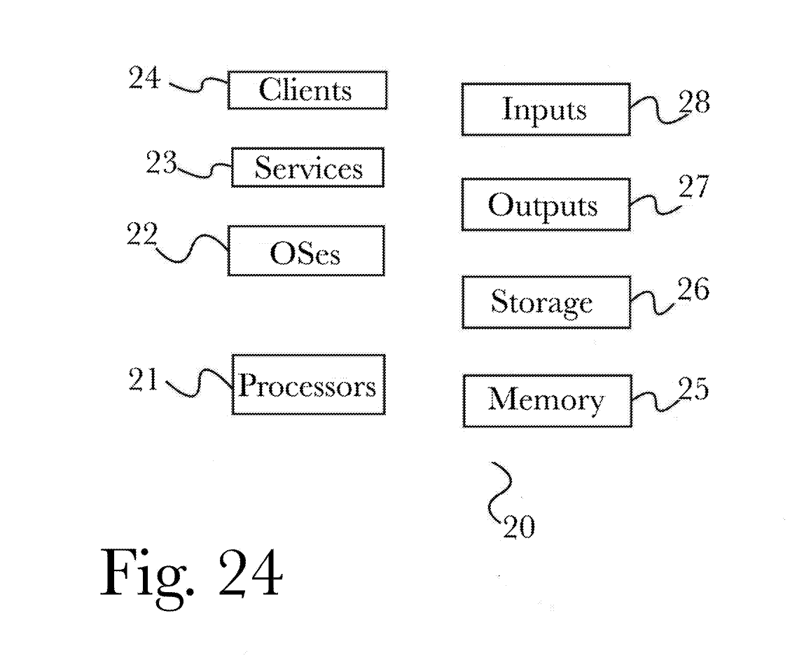

In some aspects, systems may be implemented on a standalone computing system. Referring now to FIG. 24, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 23). Examples of storage devices 26 include flash memory, magnetic hard drive, CD-ROM, and/or the like.

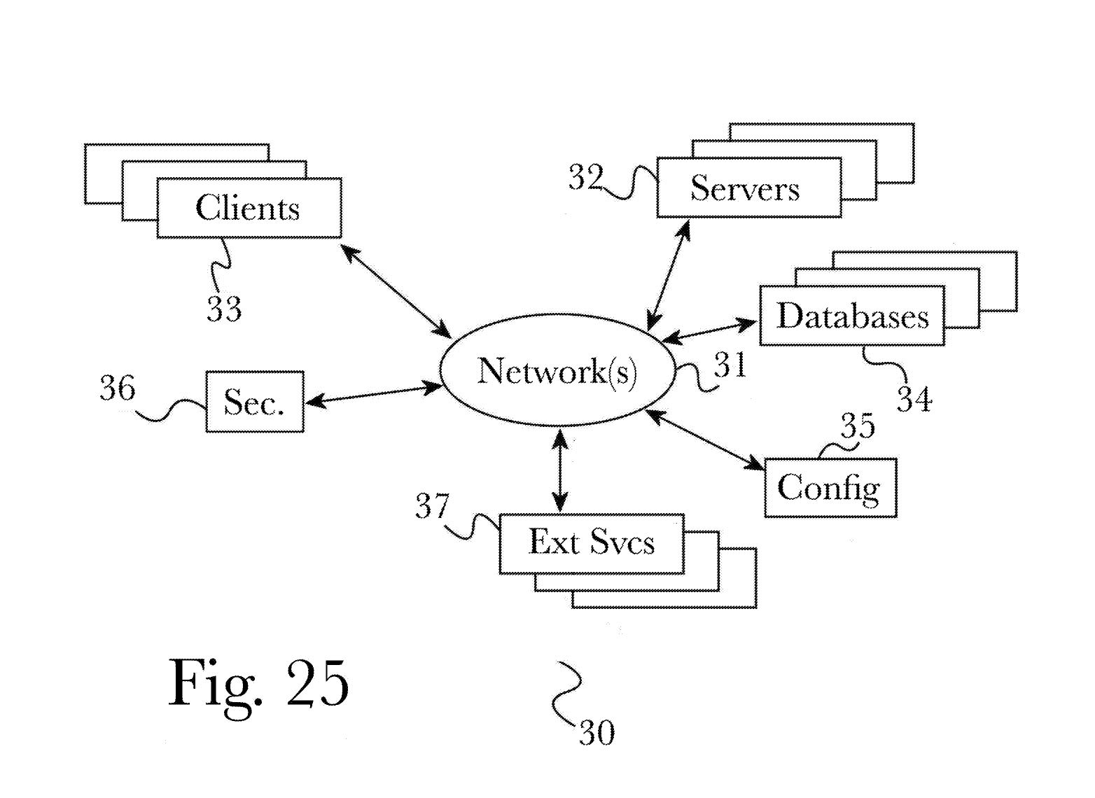

In some aspects, systems may be implemented on a distributed computing network, such as one having any number of clients and/or servers. Referring now to FIG. 25, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 24. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

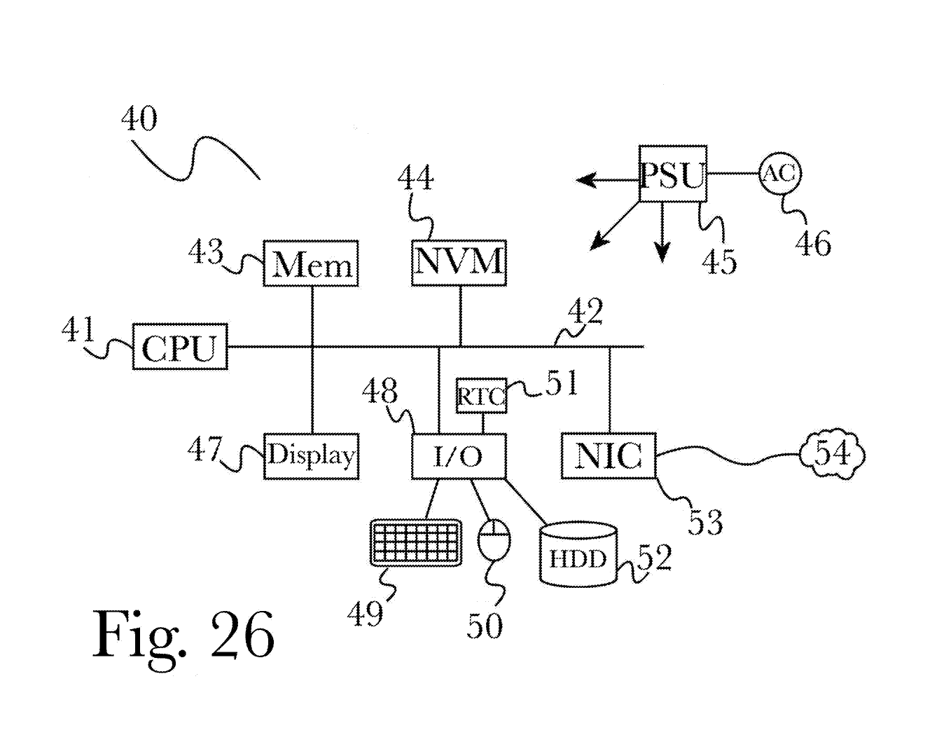

FIG. 26 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A next-generation enhanced comprehensive cybersecurity platform, comprising:
a user entity behavior analytics server comprising at least a processor, a memory, and a plurality of programming instructions stored in the memory and operating on the processor, wherein the programmable instructions, when operating on the processor, cause the processor to:
receive activity information from a plurality of next-generation endpoint protection agents;
analyze at least a portion of the activity information, the analysis comprising at least a comparison against a stored configuration;
direct the operation of a next-generation endpoint protection agent based at least in part on the analysis;
receive a plurality of notification messages via a network;
arrange at least a portion of the notification messages into a priority queue, the arrangement being based at least in part on a stored configuration;
transmit at least a notification message based at least in part on the priority queue;
a next-generation endpoint protection software agent comprising at least another processor, another memory, and another plurality of programming instructions stored in the another memory, the another plurality of programming instructions, when executed by the another processor, cause the another processor to:
collect metadata based at least in part on an operating system operating on the another processor;
capture activity information comprising at least a process operating on the another processor;
transmit at least a portion of the activity information to a user entity behavior analytics server;
receive instructions from a user entity behavior analytics server; and
stop a process from operating on the another processor based on the instructions received.

2. A method for malware detection and mitigation using a next-generation enhanced comprehensive cybersecurity platform, comprising the steps of:
collecting, at a next-generation endpoint protection software agent comprising at least another processor, another memory, and another plurality of programming instructions stored in the another memory, metadata based at least in part on an operating system operating on the another processor;
capturing activity information comprising at least a process operating on the another processor;
transmitting at least a portion of the activity information to a user entity behavior analytics server;
receiving, at a user entity behavior analytics server comprising at least a processor, a memory, and a plurality of programming instructions stored in the memory and operating on the processor, the activity information;
analyzing at least a portion of the activity information, the analysis comprising at least a comparison against a stored configuration; and
directing the operation of a next-generation endpoint protection agent based at least in part on the analysis.
